(19) United States
(12) Patent Application Publication
(10) Pub. No.: US 2024/0125924 A1
(43) Pub. Date: Apr. 18, 2024

(54) RADAR SYSTEM AND CORRESPONDING METHOD

(71) Applicant: Symeo GmbH, Neubiberg (DE)

(72) Inventors: Fabian Kirsch, Schiffdorf (DE); Christoph Mammitzsch, Neubiberg (DE); Martin Schütz, Nürnberg (DE); Mark Christmann, München (DE)

(21) Appl. No.: 18/277,002

(22) PCT Filed: Feb. 7, 2022
(86) PCT No.: PCT/EP2022/052868

§ 371 Date: Aug. 11, 2023

(30) Foreign Application Priority Data
Feb. 12, 2021 (DE) 10 2021 103 398.5
Jul. 13, 2021 (DE) 10 2021 118 074.0

(51) Int. Cl. G01S 13/931; G01S 7/02; G01S 7/282; G01S 7/285; G01S 13/28; G01S 13/42

(52) U.S. Cl. CPC G01S 13/931; G01S 7/0232; G01S 7/0235; G01S 7/282; G01S 7/285; G01S 13/282; G01S 13/426

(57) ABSTRACT

The present subject matter relates to a radar system for the detection of surroundings, in particular for a vehicle and/or a transport device, and/or for stationary application, comprising: at least one transmitting-receiving unit for transmitting and receiving radar signals, which is configured to transmit a plurality M of physical angle-modulated signals, in particular chirps, from which a plurality N of virtual angle-modulated signals, in particular chirps, can be formed, wherein each virtual signal comprises several, in particular M, sampling points which are distributed over the physical chirps.

### CLAIM OF PRIORITY

This application is a U.S. National Stage Application under 35 U.S.C. 371 from International Application No. PCT/EP2022/052868, filed Feb. 7, 2022, and published as WO 2022/171565 A1 on Aug. 18, 2022, which claims the benefit of priority of (1) DE Application No. 102021118074.0 filed Jul. 13, 2021 and (2) DE Application No. 102021103398.5 filed Feb. 12, 2021, the benefit of each of which is hereby presently claimed, and each of which are hereby incorporated by reference herein in their entirety.

### TECHNICAL FIELD

The disclosure relates to a radar system, in particular for the detection of surroundings, and a corresponding method.

### BACKGROUND

Radar methods and corresponding systems for the detection of surroundings are known in principle. In [1] (=“Concept and Implementation of a PLL-Controlled Interlaced Chirp Sequence Radar for Optimized Range-Doppler Measurements, IEEE Transactions on Microwave Theory and Techniques” (Volume: 64, Issue: 10, October 2016), Page(s): 3280-3289, DOI: 10.1109/TMTT.2016.2599875), a concept using chirp sequences is proposed in order to improve range and speed measurements, respectively, by radar. However, this concept is considered to be comparatively complex, in particular in terms of technical implementation or also with regard to the large number of correction steps proposed there.

### SUMMARY

The present subject matter proposes a radar system for the detection of surroundings, in particular for a vehicle and/or a transport device and/or for stationary application, with which comparatively precise radar measurements are possible in a comparatively simple manner. In particular, it should be possible to achieve unambiguous measurement results even for comparatively large distances and/or high speeds (relative radial speeds).

In particular, the present subject matter proposes a radar system for the detection of surroundings (preferably for the detection of a distance and/or a speed, in particular relative radial speed, of an object and/or structure of the surroundings or of a target) in particular for a vehicle (for example motor vehicle, in particular with a function for at least partially autonomous driving, or an aircraft, for example aeroplane or helicopter, in particular with a function for at least partially autonomous flying and/or unmanned) and/or for a transport device (for example for a crane) and/or for stationary application, comprising: at least one transmitting-receiving unit for transmitting and receiving radar signals, which is configured to transmit a number (in particular a plurality) N of (in particular successive, possibly temporally spaced) physical angle-modulated (in particular phase- and/or frequency-modulated) signals, in particular chirps, from which a number (in particular plurality) M of virtual angle-modulated (in particular frequency- and/or phase-modulated) signals, in particular chirps (which can overlap in time with one another), can be formed or is formed, wherein the respective virtual signal comprises several, in particular M, sampling points which are distributed over the physical chirps.

The plurality N of physical signals can in particular be individual signals of a signal sequence, wherein the individual signals are for example spaced apart from one another (with constant spacing or equidistant or at least partially—in relation to a subgroup of all signals—or all with non-constant spacing or non-equidistant).

Shape and number of the respective signals can be predetermined (for example, externally). It is also possible that the radar system comprises a unit (computing unit) that is configured to determine appropriately adapted signals as well as signal shapes on the basis of external specifications.

An idea of the disclosure is not only to actually transmit (angle modulated) physical signals, but also to form or define at least one virtual signal from the physical signals or sampling points of different physical signals.

A virtual signal may be composed of a plurality of sampling points, each of which is associated with an individual physical signal. For example, a first virtual signal may have the respective (in terms of time) first sampling point of the respective physical signals, a second virtual signal the respective second sampling point (optional: and so on).

Particularly preferably, the radar system comprises an evaluation unit (which can be partially or completely formed by the (first) transmitting-receiving unit, or can be partially or completely formed in addition to the transmitting-receiving unit), wherein the evaluation unit, from a radar signal reflected from an object of the surroundings (in particular down-mixed) received by the transmitting-receiving unit (and originally originating from the latter), determines at least one object parameter (in particular a distance or a variable dependent thereon and/or based thereon and/or a velocity, in particular radial velocity, or a variable dependent thereon and/or based thereon), wherein the evaluation unit determines the respective object parameter (that is for example the distance or the radial velocity) taking into account both (several, in particular all) sampling points within a (respective) physical signal (or taking into account the (respective) physical signal itself or the (respective) physical signals themselves) as well as (several, in particular all) sampling points within a (respective) virtual signal (or the (respective) virtual signal itself or the (respective) virtual signals themselves). Particularly preferably, the evaluation unit can determine the respective object parameter taking into account both a slow-time frequency as well as a fast-time frequency (each will be explained further below). Under a taking into account (or employing or using) the respective signal (or its sampling points) when determining the object parameter is in particular to be understood that the respective signal (or the corresponding sampling points) is evaluated (in particular directly) during said determination, for example within a corresponding calculation operation. In particular, the mere definition of a virtual signal shall not be understood as a corresponding taking into account (or use) of this signal in the determination of the object parameter.

### BRIEF DESCRIPTION OF THE DRAWINGS

Examples of embodiments are explained in more detail below with reference to the figures.

FIG. 1 a diagram of a sampling in the lateral frequency range;

FIG. 2 a 2D Fourier spectrum for different targets and limiting cases for distance and velocity;

FIG. 3 a diagram for TDM channels placed on the same virtual ramp;

FIG. 4 Fast-time FDM channels which are assigned to different fast-time frequencies such as offsets;

FIG. 5 a diagram of an interleaved transmission of two groups of physical ramps; and

FIG. 6 a schematic representation of a system comprising an autonomous vehicle and a radar system according to embodiments.

### DETAILED DESCRIPTION

The radar system according to the disclosure is comparatively efficient. In particular, comparatively few calculation steps are required to reliably determine or estimate the object parameters.

Under a fast time is to be understood in particular as a time that elapses during a respective physical signal. Alternatively or additionally, a fast time can be understood as a time that corresponds to the time interval between two (timely successive) sampling points of the respective physical signal.

Under a slow time is to be understood in particular as a time that elapses during a respective virtual signal. Alternatively or additionally, a slow time can be understood as a time that corresponds to the time interval between two (timely successive) sampling points of the respective virtual signal.

Under a fast-time frequency is to be understood in particular a signal frequency that occurs during the transmission of the physical signal.

Under a slow-time frequency is to be understood in particular a signal frequency that occurs during the consideration of a respective virtual signal and preferably is normalised to a sampling rate of the slow-time (so that it possibly can be dimensionless).

Under an object parameter is to be understood in particular a parameter which characterises the object to be detected (target or target structure) with regard to its position and/or orientation and/or locomotion (translatory and/or rotatory). Preferably, the object parameter is a single physical variable, i.e. not a parameter set.

According to a particularly preferred aspect (which is in particular combinable with the above and/or following aspects), the virtual and/or physical signals are adjustable and/or adapted to system requirements. Preferably, the virtual and/or physical signals are adjustable to a predetermined resolution and/or accuracy and/or uniqueness range for a distance and/or speed determination and/or a predetermined time-on-target. According to this idea, the system (in particular a calculation and/or evaluation unit, for example the above evaluation unit) is configured in such a way that certain specifications with regard to requirements to be achieved (for example a certain maximum speed at which an unambiguous measurement should be possible) are or can be used, in particular, in the determination or specification of virtual and/or physical signals. Specifically, corresponding virtual signals can first be defined on the basis of the specified requirements, whereby (for example in a subsequent step) corresponding physical signals are defined (and ultimately then also transmitted).

The physical and/or virtual signals can be ramped or formed by linear signals that are modulated in frequency (or each formed by one, in particular a single, ramp). The physical signals can be formed by upward ramps. Alternatively or additionally, the virtual signals can be formed by upward ramps. The physical signals can be formed by downward ramps. Alternatively or additionally, the virtual signals can also be formed by downward ramps. It is possible that the physical ramps are formed by upward ramps and the virtual signals by downward ramps. Furthermore, it is possible that the physical signals are formed by downward ramps and the virtual signals by upward ramps. Especially if the slopes of the ramps of physical and virtual signals are not equal (regarding their sign), good results can be achieved.

The plurality of physical signals (within a sequence) may be at least two or at least four or at least 10 and/or at most 1000 or at most 100. The plurality of virtual signals (associated with a particular sequence of physical signals) may be at least two or at least four or at least 10 and/or at most 1000 or at most 100 signals. The respective plurality of physical or virtual signals can also be referred to as a respective signal sequence. With such a signal sequence the corresponding radar measurement is then preferably carried out.

Preferably, the distance (d) or the variable dependent thereon (in particular the signal propagation time (T)) or the variable based thereon is determined taking into account a slow-time frequency (f_{slow}) and/or a fast-time frequency (f_{fast}) and/or a sweep rate of the virtual signals (μ_{P}) and/or a sweep rate of the physical signals (μ_{R}) and/or a signal duration (T_{P}) of the virtual signals, in particular chirp duration, and/or the mean RF transmission frequency (f_{c}), preferably taking into account (using) the following relationship or an analogue (for example having at least one different sign) relationship:

$$\\ ( \begin{matrix}{f}_{slow} \\ {f}_{fast}\end{matrix} ) = A ( \begin{matrix}d \\ v\end{matrix} )$$

$$\\ ( \begin{matrix}d \\ v\end{matrix} ) = {A}^{- 1} ( \begin{matrix}{f}_{slow} \\ {f}_{fast}\end{matrix} )$$

$$\\ with A = \frac{2}{c} [ \begin{matrix}{μ}_{P} & {f}_{c} \\ {μ}_{R} & {f}_{c}\end{matrix} ] [ \begin{matrix}1 & {T}_{P} \\ 0 & 1\end{matrix} ] .$$

Preferably, the velocity (v) or the variable dependent on it and/or based on it is determined taking into account a slow-time frequency (f_{slow}) and/or a fast-time frequency (f_{fast}) and/or a sweep rate of the virtual signals (μ_{P}) and/or a sweep rate of the physical signals (μ_{R}) and/or a signal duration (T_{P}) of the virtual signals, in particular chirp duration, and/or the mean RF transmission frequency (f_{c}), preferably taking into account (using) the following relationship or an analogue (for example having at least one different sign) relationship:

$$\\ ( \begin{matrix}{f}_{slow} \\ {f}_{fast}\end{matrix} ) = A ( \begin{matrix}d \\ v\end{matrix} )$$

$$\\ ( \begin{matrix}d \\ v\end{matrix} ) = {A}^{- 1} ( \begin{matrix}{f}_{slow} \\ {f}_{fast}\end{matrix} )$$

$$\\ with A = \frac{2}{c} [ \begin{matrix}{μ}_{P} & {f}_{c} \\ {μ}_{R} & {f}_{c}\end{matrix} ] [ \begin{matrix}1 & {T}_{P} \\ 0 & 1\end{matrix} ] .$$

Preferably, the transmission of the physical signals (signal sequence) is performed in such a way that the uniqueness range of a velocity measurement is independent of the length of the respective physical signal(s) (unlike as, for example, in [1], cf. equations (20), (21)).

Particularly preferably, the system is designed as a MIMO radar system.

In embodiments, the system may comprise at least two transmitting channels, which are preferably configured for time division multiplexing, in particular such that the corresponding transmitted signals form the same virtual signals (with a corresponding temporal offset) (that is, in particular, a respective virtual signal may be defined by corresponding sampling points of physical signals of the two or more transmitting channels).

Alternatively or additionally, the system may comprise at least two transmitting channels, which are preferably configured for frequency division multiplexing, further preferably for fast-time frequency division multiplexing and/or slow-time frequency division multiplexing.

In embodiments, at least two (in particular overlapping in time) groups of virtual signals may be defined, which are generated or defined by corresponding sequences of physical signals (in particular by time division multiplexing of the physical signals).

A distance between the individual physical signals can be equidistant or (at least with respect to a subgroup of the physical signals, possibly with respect to all physical signals) non-equidistant.

Several virtual signals may overlap in time.

The present subject matter also proposes a method for the detection of surroundings, in particular using the above system and/or the system described below, wherein at least a number/plurality M of physical (angle-modulated) signals, in particular chirps, is transmitted, at least a number/plurality N of virtual angle-modulated signals, in particular chirps, is defined, wherein each virtual signal comprises several, in particular M, sampling points, which are distributed over the physical chirps, and wherein at least one object parameter is determined from a radar signal which is reflected, in particular down-mixed, from an object in the surroundings and is received by the transmitting-receiving unit, wherein the respective object parameter is determined taking into account both (several) sampling points within a (respective) physical signal and (several) sampling points within a (respective) virtual signal.

Further method features result in particular from the above and/or following description of functions as well as configurations of the system. These can be carried out as corresponding method steps (whereby corresponding evaluation and/or calculation steps can be carried out by one of the units mentioned above and/or below or by any other calculation and/or evaluation unit).

The present subject matter also proposes a vehicle (in particular motor vehicle, for example autonomous motor vehicle, in particular car and/or truck) and/or a stationary device, comprising the above system and/or configured for carrying out the above method.

The present subject matter also proposes a computing and/or evaluation device which is configured for carrying out the above method and/or has the above features which are described for an/the evaluation device.

The present subject matter also proposes a computer-readable storage medium, in particular for carrying out the above method and/or as a component of the above system and/or the above evaluation unit, which contains instructions which cause at least one processor to implement the following steps when the instructions are executed by a processor:

Determining at least one object parameter from a radar signal reflected, in particular down-mixed, by an object of the surroundings and received by the transmitting-receiving unit, wherein the respective object parameter is determined taking into account both sampling points within a physical signal as well as sampling points within a virtual signal. Further steps according to the embodiment result from the above and/or following description.

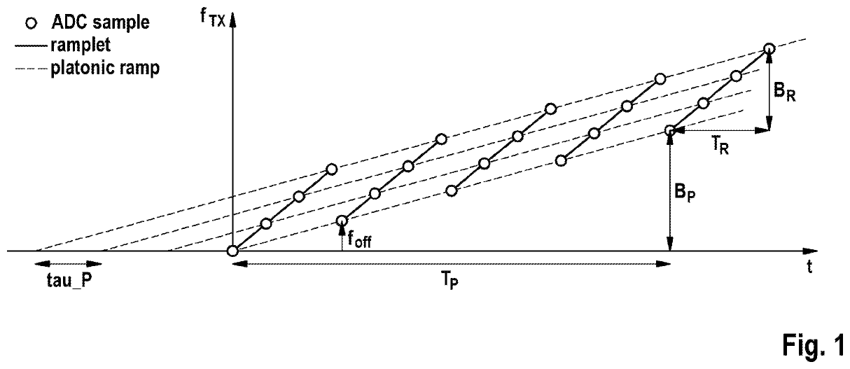

In FIG. 1, physical chirps (a chirp may also be referred to as a ramplet) are shown with corresponding sampling points (generated by an ADC) from which, in turn, virtual ramps (also referred to as platonic ramps) result in a time-frequency plane. In particular, these are set in such a way that a subsequent method or algorithm for processing is able to reconstruct the physical distance and/or (radial) velocity of a target, which may possibly by a 2D point spread function (and its side lobes be identified). The sampling points collectively produce an ADC sample.

An ADC sampling (ADC=Anlag-Digital-Converter) within the chirps can be called a fast-time sampling. The sampling points between the chirps (on the same virtual ramp) can be called slow-time sampling points.

The chirps and virtual (platonic) ramps may be executed as upward or downward ramps (in FIG. 1 respective upward chirps are shown). In particular, it is possible that the physical signals (chirps) are executed as upward ramps and the virtual signals as downward ramps (or vice versa). This can influence the sign of the slow-time frequency or fast-time frequency of a target's beat signal, as explained or defined further below. In the following, for illustrative purposes, an embodiment with upward ramps as physical signals and upward ramps as virtual signals is explained (without limitation of generality).

FIG. 1 is shown as an example of this.

The characteristics of the physical signals (chirps) may depend on requirements in a uniqueness range (for range and Doppler), a target resolution and a time-on-target. The input parameters are preferably:
range resolution dR
unique range of distance Rₘₐₓ
unique Doppler range vₘₐₓ
time-on-target T_{target}.

System parameters that may depend on the radar sensor are given by:
ADC sampling rate fₛ, sampling period tₛ
HF carrier frequency f₀

From this, modulation parameters of the physical ramps can result as follows:

$$\\ virtual ( platonic ) ramp distance ( in Fig . 1 : tau_P ) : {τ}_{P} = \frac{c}{4 {f}_{0} {v}_{max}}$$

$$\\ virtual bandwidth : {B}_{P} = \frac{c}{2 dR}$$

$$\\ virtual ramp duration : {T}_{P} = {T}_{target}$$

$$\\ virtual ramp sweep rate : {μ}_{P} = \frac{{B}_{P}}{{T}_{P}} = \frac{c}{2 {T}_{R} {R}_{max}}$$

$$\\ frequency increment : {f}_{off} = {μ}_{P} {T}_{R} = \frac{c}{2 {R}_{max}}$$

$$\\ chirp duration {T}_{R} = \frac{{T}_{P} dR}{{R}_{max}}$$

$$\\ number of chirps N = \frac{{B}_{P}}{{T}_{R}} = \frac{{R}_{max}}{{d}_{R}}$$

$$\\ chirp bandwidth {B}_{R} = \frac{c ( {τ}_{P} + {t}_{s} )}{2 {R}_{max} {t}_{s}}$$

$$\\ chirp sweep rate {μ}_{R} = \frac{{B}_{R}}{{T}_{R}}$$

A single target at a distance d and/or with the variable dependent of it of a round-trip-delay time τ, in particular a time-dependent distance d(t) and/or a variable dependent of it round-trip-delay time τ(t) of a target with a (radial) velocity can produce the following beat signal (down-mixed signal):

f_{b}(t,k)=exp{−j2π(f₀τ(t+kT_{R})+f_{off}τ(t+kT_{R})+μ_{R}tτ(t+kT_{R})−½μ_{R}τ(t+kT_{R})²)}

Where t designates the time within the physical signal (fast-time) and k the index of the physical signal within the virtual signal (slow-time).

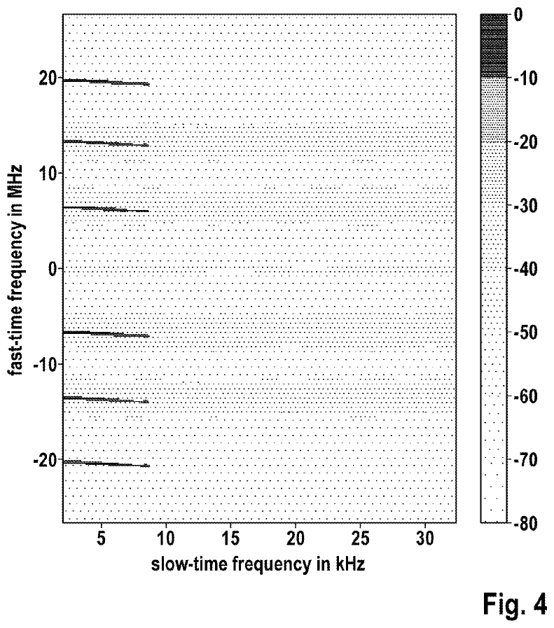

By transformation of the beat signal into a 2D Fourier spectrum (without additional phase and/or frequency correction, as e.g., in [1], cf. FIG. 4), the (normalised, see above) slow-time frequencies and fast-time frequencies of the target are obtained.

This equation shows in particular that the distance and velocity axes are not (necessarily) orthogonal to each other, since the target distance and target velocity are integrated in both the fast-time as well as the slow-time frequency. For this reason, this 2D Fourier spectrum can also be designated as unaligned space.

With the following affine transformation it is transformed between the unaligned space and the distance-velocity space:

$$\\ ( \begin{matrix}{f}_{slow} \\ {f}_{fast}\end{matrix} ) = A ( \begin{matrix}d \\ v\end{matrix} )$$

$$\\ ( \begin{matrix}d \\ v\end{matrix} ) = {A}^{- 1} ( \begin{matrix}{f}_{slow} \\ {f}_{fast}\end{matrix} )$$

$$\\ with A = \frac{2}{c} [ \begin{matrix}{μ}_{P} & {f}_{c} \\ {μ}_{R} & {f}_{c}\end{matrix} ] [ \begin{matrix}1 & {T}_{P} \\ 0 & 1\end{matrix} ] .$$

This can be done on the basis of a (resulting) target list and in particular not on the basis of an entire frequency spectrum, optionally after complete MIMO processing and/or a (in particular subsequent) CFAR processing (CFAR=constant false alarm rate) and/or a target detection.

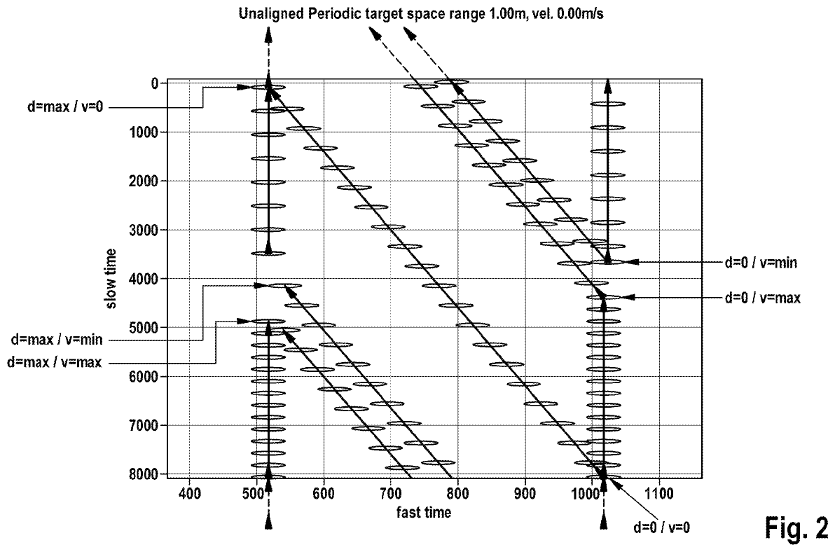

FIG. 2 shows a 2D Fourier spectrum of the received signal (beat signal), which has a large number of superimposed target echoes. From this spectrum, distances and velocities of the targets can according to embodiment be determined in accordance with the equations X. The 2D Fourier spectrum shows different targets and limiting cases for distance and velocity. Specific limiting cases (e.g., maximum distance/maximum velocity in terms of the uniqueness) are shown. “slow time”/“fast time” stands for “slow-time frequency”/“fast-time frequency”.

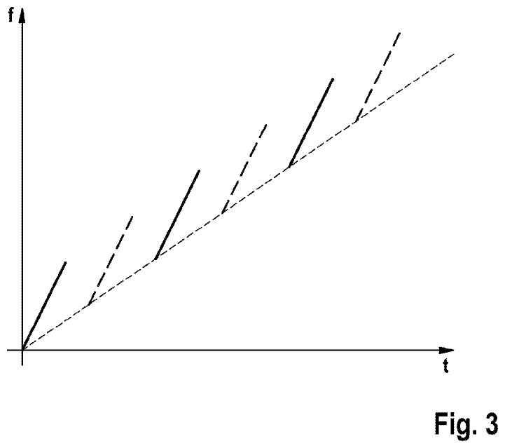

FIG. 3 shows TDM (time division multiplexing) MIMO channels which are arranged on the same virtual ramp (or placed on the same virtual ramp).

Basically, with TDM, several transmitters are switched on one after the other. With this modulation waveform, it is preferred to scan the same virtual ramps with all TX channels.

In this case, the phase error correction of the kth TDM channel is a linear phase shift along the slow-time frequency (sampling frequency).

H_{TDM,k}(f_{slow})=exp{−j2τkT_{R}f_{slow}}

In the TDM method, the modulation parameters can be adjusted. This can be done by reducing the chirp duration of the physical signals and/or by increasing the virtual ramp durations, wherein in each case the other parameters can be adjusted to maintain the required ranges for resolution and uniqueness. In particular, it can be distinguished between the physical ramp duration and the distance between two physical ramps within a TDM channel.

FIG. 4 shows fast-time FDM channels which are assigned to different fast-time frequency offsets f₀. By a staggered frequency modulation of the transmitters within the chirp, the TX channels can be separated on the fast-time frequency axis, as shown in FIG. 4. The beat signal expands to

$$\\ {f}_{b} ( t , k ) = exp \{ - j 2 π ( {f}_{0} τ ( t + {kT}_{R} ) + {f}_{off} τ ( t + {kT}_{R} ) + {μ}_{R} t τ ( t + {kT}_{R} ) - \frac{1}{2} {μ}_{R} {τ ( t + {kT}_{R} )}^{2} - {f}_{0} t + {f}_{0} τ ( t + {kT}_{R} ) ) \}$$

In such a MIMO modulation, a phase error caused by an offset modulator and an offset frequency f₀ can be corrected by:

H_{FTFDM,f}_{₀}(f_{fast},f_{slow})=exp{−j2πf₀τ(f_{fast},f_{slow})}

wherein τ (f_{fast}, f_{slow}) is the round-trip time of a target at the slow-time frequency f_{slow} and fast-time frequency f_{fast}.

By a staggered frequency modulation of transmitters along a virtual ramp, the TX channels can be separated on a slow-time frequency axis, similar to a fast-time FDM.

To increase a resolution/sensitivity of the fast-time frequency or slow-time frequency, additional groups of physical and/or virtual ramps can be transmitted interleaved. This allows a target phase from one group to be compared to another and a phase deviation or frequency to be estimated along an additional axis. This additional axis can be called, for example, very-slow time.

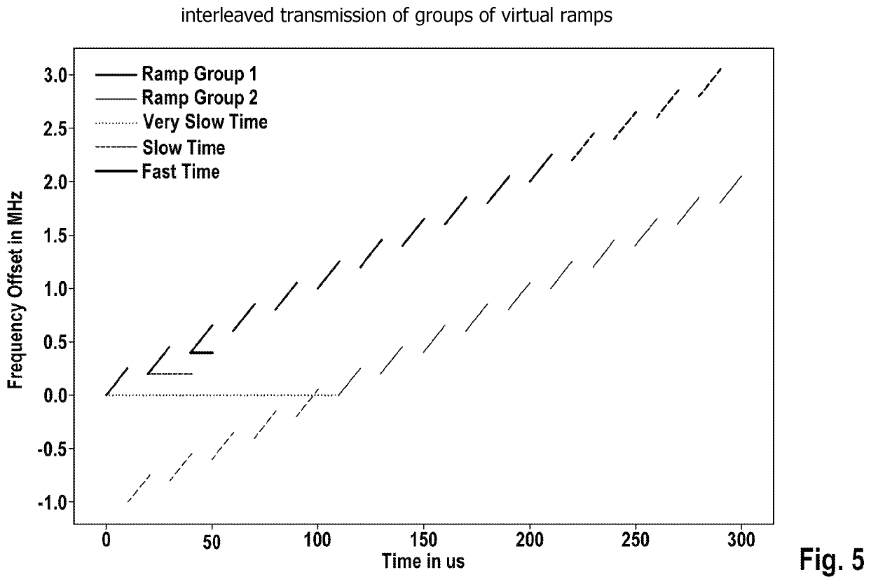

In FIG. 5 a corresponding example of an interleaved transmission of two groups of virtual ramps is shown. This can, for example, enable the comparison of a target phase from group to group. Furthermore, a new axis (very-slow-time, in addition to fast-time and slow-time) can be introduced.

In general, it is possible to string together the physical and/or virtual signals in a non-equidistant manner to perform a reconstruction of the slow-time frequency and/or fast-time frequency of the target with methods alternative to a Fourier transform, in particular compressed-sensing. This may be advantageous to extend the resolution and/or uniqueness range of the frequency estimation for certain target scenarios.

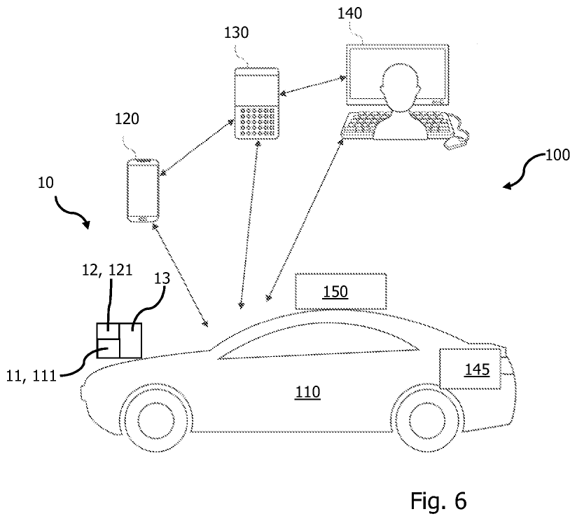

FIG. 6 shows a system 100 comprising an autonomous vehicle 110 and a radar measurement system (radar system) 10 according to embodiments. The radar measurement system 10 comprises a first radar unit 11 with at least one first radar antenna 111 (to transmit and/or receive corresponding radar signals), and optionally a second radar unit 12 with at least one second radar antenna 121 (to transmit and/or receive corresponding radar signals), and an evaluation unit 13.

The system 100 may have a passenger input device and/or output device 120 (passenger interface), a vehicle coordinator 130 and/or an external input and/or output device 140 (remote expert interface; for example for a control center). In embodiments, the external input and/or output device 140 may allow a person and/or device external (to the vehicle) to make and/or modify settings on or in the autonomous vehicle 110. This external person/device may be different from the vehicle coordinator 130. The vehicle coordinator 130 may be a server.

The system 100 enables the autonomous vehicle 110 to have a driving behaviour dependent on parameters that to modify and/or set by a vehicle passenger (for example, by means of the passenger input device and/or output device 120) and/or other persons and/or devices involved (for example, via the vehicle coordinator 130 and/or the external input and/or output device 140). The driving behaviour of an autonomous vehicle may be predetermined or modified by (explicit) input or feedback (for example, by passenger specifying a maximum speed or a relative comfort level), by implicit input or feedback (for example, a pulse of a passenger), and/or by other suitable data and/or communication methods for a driving behaviour or preferences.

The autonomous vehicle 110 is preferably a fully autonomous motor vehicle (e.g., car and/or truck), but may alternatively or additionally be a semi-autonomous or (other) fully autonomous vehicle, for example a watercraft (boat and/or ship), a (particularly unmanned) aircraft (plane and/or helicopter), a driverless motor vehicle (e.g., car and/or truck) et cetera. Additionally or alternatively, the autonomous vehicle may be configured in such way that it can switch between a semi-automatic state and a fully-automatic state, wherein the autonomous vehicle may have characteristics that may be associated with both a semi-automatic vehicle as well as a fully-automatic vehicle (depending on the state of the vehicle).

The autonomous vehicle 110 preferably comprises an on-board computer 145.

The evaluation unit 13 may be at least partially arranged in and/or on the vehicle 110, in particular (at least partially) integrated into the on-board computer 145, and/or (at least partially) integrated into a calculation unit in addition to the on-board computer 145. Alternatively or additionally, the evaluation unit 13 may be (at least partially) integrated in the first and/or second radar unit 11, 12. If the evaluation unit 13 is (at least partially) provided in addition to the on-board computer 145, the evaluation unit 13 may be in communication with the on-board computer 145 so that data can be transmitted from the evaluation unit 13 to the on-board computer 145 and/or vice versa.

Additionally or alternatively, the evaluation unit 13 may be (at least partially) integrated with the passenger input device and/or output device 120, the vehicle coordinator 130, and/or the external input and/or output device 140. In particular, in such a case, the radar measurement system may comprise a passenger input device and/or output device 120, a vehicle coordinator 130, and/or an external input and/or output device 140.

In addition to the at least one radar unit 11, 12, the autonomous vehicle 110 may comprise at least one other sensor device 150, (for example, at least one computer vision system, at least one LIDAR, at least one speed sensor, at least one GPS, at least one camera, etc.).

The on-board computer 145 may be configured to control the autonomous vehicle 110. The on-board computer 145 may further process data from the at least one sensor device 150 and/or at least one other sensor, in particular a sensor provided or formed by at least one radar unit 11, 12, and/or data from the evaluation unit 13 to determine the status of the autonomous vehicle 110.

Based on the status of the vehicle and/or programmed instructions, the on-board computer 145 can preferably modify or control the driving behaviour of the autonomous vehicle 110. The evaluation unit 13 and/or the on-board computer 145 is (are) preferably a (general) computation unit adapted for an I/O communication with a vehicle control system and at least one sensor system, but may additionally or alternatively be formed by any suitable computation unit (computer). The on-board computer 145 and/or the evaluation unit 13 may be connected to the internet via wireless connection. Alternatively or additionally, the on-board computer 145 and/or the evaluation unit 13 may be connected to any number of wireless or wired communication systems.

For example, any number of electrical circuits, in particular as part of the evaluation unit 13 and/or the on-board computer 145, the passenger input device and/or output device 120, the vehicle coordinator 130 and/or the external input and/or output device 140 may be implemented on a circuit board of a corresponding electronic device. The circuit board may be a general circuit board (“circuit board”) that may have various components of an (internal) electronic system, an electronic device and connections for other (peripheral) devices. Specifically, the circuit board may have electrical connections via which other components of the system may communicate electrically (electronically). Any suitable processors (for example, digital signal processors, microprocessors, supporting chipsets, computer-readable (non-volatile) memory elements, etc.) may be coupled to the circuit board (depending on appropriate processing requirements, computer designs, etc.). Other components, such as an external memory, additional sensors, controllers for audio-video playback, and peripheral devices may be connected to the circuit board, such as plug-in cards, via cables, or integrated into the board itself.

In various embodiments, functionalities which are described herein may be implemented in emulsified form (as software or firmware), with one or more configurable (for example, programmable) elements that are arranged in a structure that enables that function. The software or firmware providing the emulation may be provided on a (non-volatile) computer-readable storage medium comprising instructions that allow one or more processors to perform the corresponding function (the corresponding process).

The above description of the embodiments shown does not purport to be exhaustive or restrictive as to the exact embodiments as described. While specific implementations of and examples of various embodiments or concepts have been described herein for illustrative purposes, deviating (equivalent) modifications are possible as will be apparent to those skilled in the art. These modifications may be made with reference to the detailed description above or to the figures.

Various embodiments may include any suitable combination of the embodiments described above, including alternative embodiments of embodiments described above in conjunctive form (e.g., the corresponding “and” may be an “and/or”).

In addition, some embodiments may comprise one or more objects (e.g., in particular, non-volatile computer-readable media) with instructions stored thereon that, when executed, result in an action (a method) according to any one of the embodiments described above. In addition, some embodiments may comprise devices or systems having any suitable means for performing the various operations of the embodiments described above.

In certain contexts, the embodiments discussed herein may be applicable to automotive systems, in particular autonomous vehicles (preferably autonomous automobiles), (safety-critical) industrial applications and/or industrial process controls.

Furthermore, parts of the described radar system or the described radar measurement system (or in general: wave-based measurement system) may comprise electronic circuits to perform the functions as well as methods described herein. In some cases, one or more parts of the respective system may be provided by a processor which is specifically configured for performing the functions as well as method steps described herein. For example, the processor may include one or more application-specific components, or it may include programmable logic gates which are configured in such a way that they perform the functions described herein.

At this point, it should be noted that all the parts or functions described above individually and in any combination, in particular the details shown in the drawings, are claimed as essential to the disclosure. Modifications thereof are familiar to the person skilled in the art.

Furthermore, it is pointed out that the scope of protection as broad as possible is sought. In this respect, the disclosure contained in the claims can also be made more precise by features which are described with further features (even without these further features necessarily being included). It is explicitly pointed out that round brackets and the term “in particular” shall emphasise the optionality of features in the respective context (which is not intended to mean, conversely, that without such identification a feature is to be regarded as mandatory in the corresponding context).

1. A radar system for the detection of surroundings, the system comprising:
at least one transmitting-receiving unit for transmitting and receiving radar signals, which is configured to transmit a plurality M of physical angle-modulated signals comprising physical chirps, from which a plurality N of virtual angle-modulated signals, are formed, wherein each virtual signal comprises M sampling points distributed over the physical chirps, and
at least one evaluation unit configured to determine at least one object parameter from a radar signal reflected from an object of the surroundings, the radar signal received by the transmitting-receiving unit,
wherein the evaluation unit is configured to determine the at least one object parameter using sampling points from within a respective physical signal and sampling points within a respective virtual signal.

2. The system according to claim 1, wherein the at least one transmitting-receiving unit is configured to adjust at least one of the virtual or physical signals to a specification for a parameter comprising a resolution, an accuracy, a unique distance, a velocity, or a time-on-target.

3. The system according to claim 1, wherein at least one of the physical or virtual signals are modulated in frequency, comprising a frequency ramp.

4. The system according to claim 1, wherein the evaluation unit is configured to determine a distance (d) or a variable based thereon, and a velocity (v) or a variable based thereon, taking into account a slow-time frequency (f_{slow}) and a fast-time frequency (f_{fast}) and a sweep rate of the virtual signals (μ_{P}) and a sweep rate of the physical signals (μ_{R}) and a signal duration (T_{P}) of the virtual signals, a mean RF transmission frequency (f_{c}).

5. The system according to claim 1, wherein the at least one transmitting-receiving unit forms a portion of a multi-input multi-output (MIMO) radar system.

6. The system according to claim 1, wherein the at least one transmitting-receiving unit is configured to operate in relation to at least two transmitting channels to establish time division multiplexing such that the corresponding transmitted signals form the same virtual signals.

7. The system according to claim 1, wherein the at least one transmitting-receiving unit is configured to operate in relation to at least two transmitting channels to establish frequency division multiplexing, with the frequency division multiplexing comprising at least one of fast-time frequency division multiplexing or slow-time frequency division multiplexing.

8. The system according to claim 1, wherein the evaluation unit is configured to define at least two groups of virtual or physical signals, which are interleaved by multiplexing.

9. The system according to claim 1, wherein a distance between respective physical signals is equidistant.

10. The system according to claim 1, wherein a distance between respective physical signals is non-equidistant.

11. The system according to claim 1, wherein the at least one object parameter comprises a distance or a speed, or a parameter based on the distance or the speed.

12. A method for the detection of surroundings, comprising:
transmitting at least one plurality M of physical angle-modulated signals;
establishing at least one plurality N of virtual angle-modulated signals, where each virtual signal comprises several sampling points distributed over the M physical signals;
receiving a radar signal reflected from an object; and
determining at least one object parameter from the received radar signal, using sampling points from both a physical signal and a virtual signal.

13. The method of claim 12, further comprising adjusting at least one of the virtual or physical signals to a specification for a parameter comprising a resolution, an accuracy, a unique distance, a velocity, or a time-on-target.

14. The method of claim 12, wherein the physical and virtual signals are modulated in frequency.

15. The method of claim 12, wherein determining the object parameter comprises taking into account a slow-time frequency, a fast-time frequency, a sweep rate of the virtual signals, a sweep rate of the physical signals, a signal duration of the virtual signals, and a mean RF transmission frequency.

16. The method of claim 12, wherein transmitting comprises transmitting from at least two channels configured for time division multiplexing or frequency division multiplexing.

17. The method of claim 12, further comprising establishing at least two groups of virtual or physical signals and interleaving the groups.

18. The method of claim 12, wherein a distance between individual physical signals is equidistant.

19. The method of claim 12, wherein a distance between individual physical signals is non-equidistant.

20. The method of claim 12, wherein the surroundings are surroundings of a vehicle.
